(19) United States
(12) Patent Application Publication
(10) Pub. No.: US 2008/0274718 A1
(43) Pub. Date: Nov. 6, 2008

(54) RESTRICTED ACCESS FULL BAND REPEATER

(75) Inventor: Michael J. ROPER, Ottawa (CA)

Correspondence Address: OGILVY RENAULT LLP, 1981 MCGILL COLLEGE AVENUE, SUITE 1600, MONTREAL, QC, H3A2Y3, CA

(73) Assignee: SPOTWAVE WIRELESS LIMITED, OTTAWA (CA)

(21) Appl. No.: 12/114,274

(22) Filed: May 2, 2008

Related U.S. Application Data
(60) Provisional application No. 60/915,737, filed on May 3, 2007.

(51) Int. Cl. H04M 1/66

(52) U.S. Cl. 455/411

(57) ABSTRACT

A method and system for restricting access to communications services of a network by wireless terminals within a coverage area of a repeater. A controller attempts to authenticate a wireless terminal within a coverage area of a repeater. If the authentication attempt is successful, an up-link path of the repeater is enabled to permit access to the communication services. Otherwise, if the authentication attempt is not successful, the uplink path is disabled to deny access to the communication services.

### CROSS-REFERENCE TO RELATED APPLICATIONS

This application claims priority to U.S. Provisional Application No. 60/915,737, filed May 3, 2007, the entirety of which is hereby incorporated by reference.

### MICROFICHE APPENDIX

Not Applicable.

### TECHNICAL FIELD

The present application relates in general to wireless communications and, in particular, to a restricted access full band repeater.

### BACKGROUND OF THE INVENTION

Wireless macro networks such as cellular, PCS, 3G and WiMax provide connectivity to mobile and portable wireless devices, such as cell phones through fixed Base-Stations. The base-stations are deployed to cover the major population areas and other sites where the demand for connectivity through mobile devices is high. However, due to the variation in topography and building materials, there are many buildings where the signal inside the building is inadequate to provide connectivity, and where is not economic to add new base-stations to increase the signal level. An example is a building that is at the edge of the macro network, where the signal level is low even on the exterior of the building.

Increasingly this problem is solved by installing an off-air repeater system to increase the signal level inside the building. An off air repeater comprises, at a minimum, a donor antenna, a bi-directional amplifier and a coverage antenna that are connected by an RF cable, as shown in FIG. 1. The donor antenna is used to communicate to the base-station, and is generally located outside the building. The coverage antenna is used to propagate the signal inside the building and so communicate with a mobile device located inside the building. The bi-directional amplifier is necessary to overcome the losses of the cables and the propagation loss inside and outside the building.

The bi-directional amplifier therefore provides sufficient gain to signals in the downlink (DL, base-station to mobile) and uplink (UL, mobile to base-station) directions to overcome these losses and allow the mobile device top communicate with the base-station. The BDA can be designed to operate over a full frequency band of operation. For example in N. America the following bands are used for cellular mobile services:

Cell band UL: 824-849 MHz, DL 869-894 MHz

PCS band UL: 1850-1910 MHz, DL 1930-1990 MHz

However, in any given area, there are usually several Wireless Service Providers (WSP) operating mobile networks in the same spectrum band, each with a separate spectrum allocation, which may consist of one or more sub bands within the full band. In many cases the WSP supplies or is responsible for the off-air repeater described above and which is used to provide coverage inside a private residence or place of work where coverage is otherwise limited or unavailable. It is therefore highly desirable in this type of deployment that the off-air repeater only re-transmits signals only within the responsible WSP's spectrum allocation, to comply with the spectrum use agreements under which the WSP operates, and also for commercial reasons, i.e. to avoid indirectly subsidizing improvements to another WSP network.

The band of operation of the of air repeater is conventionally limited by placing filters in the downlink and uplink paths of the BDA. To meet noise figure and output power requirements, these filters are normally placed between the input and output gain stages of the BDA, as shown in FIG. 2. However, in order to provide a useful attenuation of the signals in adjacent carriers' bands, these filters must have a sharp roll-off; a specification of >30 dB attenuation at 1 MHz from band edge is typical and can currently be achieved using SAW filter or digital filter technology. The current limitations of these technologies require the conversion by a mixer of the RF frequencies passed by the repeater to a lower IF where the filters are implemented. After filtering and adding gain to overcome the filter losses, which can exceed 25 dB in a SAW device, the signals are mixed back to the correct RF frequency by a second mixer. Further RF filters are required before these mixers to suppress image responses and to prevent local oscillator from being amplified and radiated by the repeater. A typical implementation based on a SAW filter for a North American Cellular Band repeater is shown in FIG. 3. Note that two IF filters are required because, in the North American 800 MHz Cellular Band, each spectrum allocation is split into two separate sub-bands.

The full implementation of a sub-band filter therefore adds considerable complexity and typically doubles the cost of the materials required to assemble an off-air repeater. A further problem with SAW filters is that the bandwidth cannot be adjusted, and so the filters must be physically changed to support changes in spectrum use (for example through the merger of two service providers). Alternatively a switched bank of filters can be used, but that adds further cost and complexity to the IF stages of the repeater.

The same basic configuration is also required if digital signal processing technology is used to provide sub-band filtering, due to the limited bandwidth of the analog-digital conversion devices and digital processors required in this implementation. It therefore remains highly desirable to provide a lower cost means of carrier specific operation in an off-air repeater.

### SUMMARY OF THE INVENTION

One aspect of the present disclosure provides a method of restricting access to communications services of a network by wireless terminals within a coverage area of a repeater. The method comprises attempting to authenticate a wireless terminal within a coverage area of a repeater; if the authentication attempt is successful, enabling an up-link path of the repeater to permit access to the communication services; and if the authentication attempt is not successful, disabling the uplink path to deny access to the communication services.

Another aspect of the present disclosure provides a repeater for providing restricted access to communications services of a network by wireless terminals within a coverage area of the repeater. The repeater includes a controller for attempting to authenticate a wireless terminal within the coverage area of the repeater; and a mute control for selectively enabling or disabling an up-link path of the repeater, based on the result of the authentication attempt.

Another aspect of the present disclosure provides a method of restricting access to communications services of a network by wireless terminals within a coverage area of a repeater. The method comprises monitoring uplink power of the repeater with the uplink being enabled for transmissions above a pre-determined threshold; if a signal is detected above the threshold, attempting to authenticate a respective wireless terminal within a coverage area of the repeater; if the authentication attempt is successful, leaving an up-link path of the repeater enabled to permit access to the communication services; and if the authentication attempt is not successful, disabling the uplink path momentarily to deny access to the communication services.

Another aspect of the present disclosure provides a method of restricting access to communications services of a network by wireless terminals within a coverage area of a repeater. The method comprises sending a message from the wireless terminal to the repeater over a wireless link whenever the wireless terminal needs to transmit to a macro network; decoding and authenticating the message at the repeater to determine whether the originating wireless terminal is authorized to use the repeater; if the authentication attempt is successful, leaving an up-link path of the repeater enabled to permit access to the communication services by the wireless terminal; and if the authentication attempt is not successful, disabling the up-link path to deny access to the communication services by the wireless terminal.

The remaining sections of this document describe an alternative means of providing carrier specific operation in a full band repeater. The Restricted Access Full Band Repeater (RAFBR) provides coverage inside buildings in the same general way as a conventional repeater. However instead of using sub-band filtering to limit access to the outdoor network of a specific carrier, the RAFBR uses an authentication process to identify and allow network access only to a limited number of approved mobile wireless terminals—i.e. those authorized by the responsible Wireless Service Provider to use the off-air repeater.

The authentication process used by RAFBR is most conveniently implemented using a wireless, protocol that uniquely identifies an authorized wireless terminal to the repeater. Both short range and longer range wireless systems may be used for this purpose. Network access for un-authorized phones can be prevented by muting the uplink (reducing the gain to a low level) if the authentication is not successful, and thus preventing the signal from an unauthorized mobile being transmitted back to the network. The Restricted Access Full Band Repeater is suited to applications in buildings such as a small office or residence, where the users do not change often and can be readily identified, i.e. employees or family members.

In smaller buildings, where only a low power signal is required to provide coverage, the repeater downlink may transmit over the full band and not contravene regulatory or spectrum use agreements. For example in the USA, a maximum signal level of up to −13 dBm may be transmitted outside the WSP defined band by a repeater. The relatively low power signals transmitted in this direction prevent the repeater having any impact on other service providers spectrum use, as they fall to a very low level outside the building.

If a larger coverage area is required than can be provided with a low Downlink Power, the RAFBR may be equipped with sub-band filters in the Downlink direction only. This elimination of the filters in the uplink still provides a substantial reduction in cost and complexity.

A block diagram of the low power restricted access Full Band Repeater is shown in FIG. 4. It comprises the full band repeater shown in FIG. 1 with an additional subsystem to perform authentication of phones that are inside the coverage area. The output of this subsystem is a mute signal which is used to reduce the gain in the UL direction to a very low value. The DL is equipped with an automatic gain control which limits the downlink composite power to a level that ensures any unwanted (other carrier) signals fall below the regulatory limit for out-of-band transmissions. This also ensures that when installed, the DL power will be reduced to a level which will not be detectable outside the building and so will not cause interference on the other Wireless Service Providers networks.

### BRIEF DESCRIPTION OF THE DRAWINGS

Further features and advantages of the present invention will become apparent from the following detailed description, taken in combination with the appended drawings, in which:

FIG. 1 is a block diagram schematically illustrating a conventional Off-Air Repeater system;

FIG. 2 is a block diagram schematically illustrating a conventional Off-Air Repeater system with sub-band filters;

FIG. 3 is a block diagram schematically illustrating a conventional Off-Air Repeater system with SAW-based sub-band filtering;

FIG. 4 is a block diagram schematically illustrating a restricted access Off-Air Repeater system in accordance with a representative embodiment of the present invention; and

FIG. 5 is a block diagram schematically illustrating a restricted access Off-Air Repeater system in accordance with a second representative embodiment of the present invention.

It will be noted that throughout the appended drawings, like features are identified by like reference numerals.

### DETAILED DESCRIPTION OF THE PREFERRED EMBODIMENT

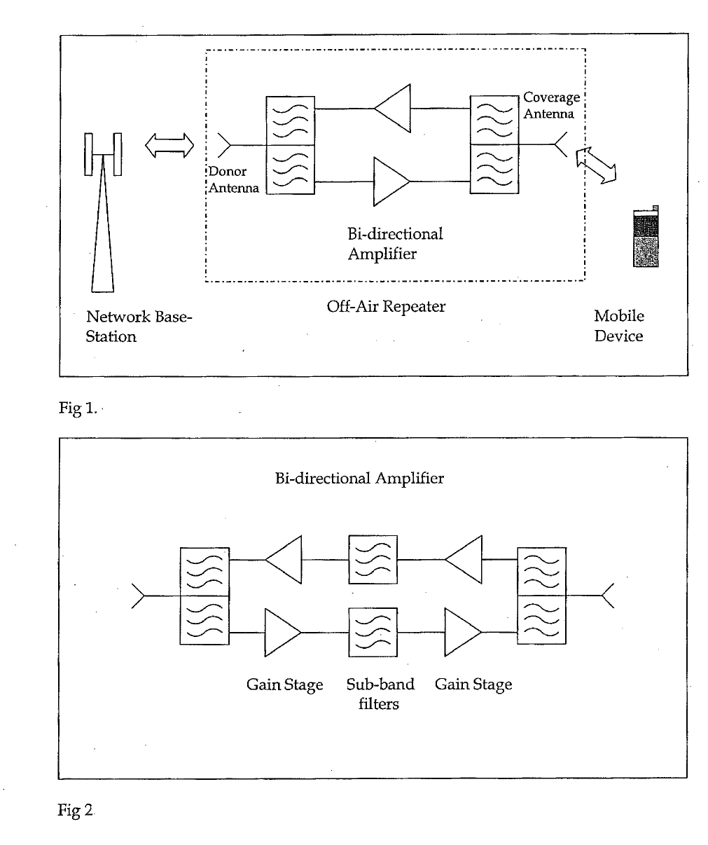

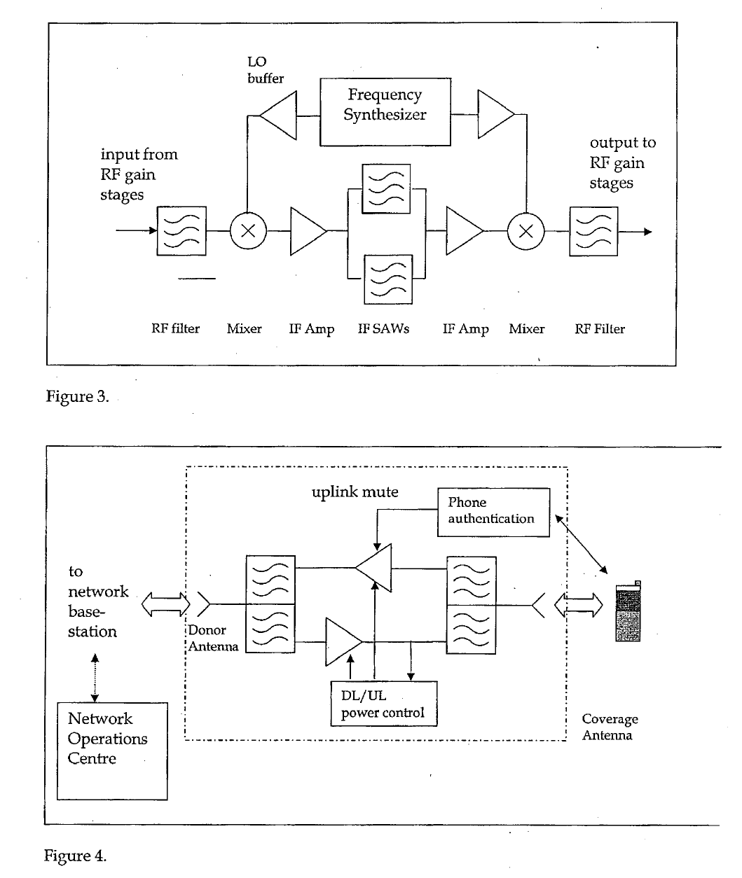

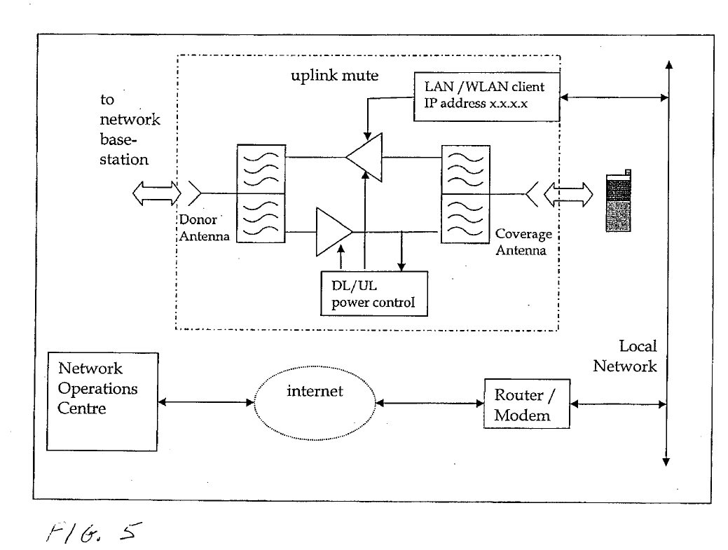

The present invention provides a restricted access full band repeater system. Representative embodiments of the system are described below with reference to FIGS. 1-5. In general, the restricted access full band repeater attempts to authenticate any users' wireless terminals within the coverage area of the repeater. If the authentication attempt is successful, an uplink path of the repeater is enabled, so that the wireless terminal can access network services of the wireless network. This operation has the effect of restricting access to the wireless network to authorized users.

In the following description, the present invention is described by way of example embodiments in which access is restricted to wireless terminals authorized by a predetermined network service provider (or network carrier). These embodiments are advantageous in that they enable operation that closely approximates carrier-specific operation described above, but without the need for expensive sub-band filtering. However, it will be appreciated that the present invention is not restricted to this operation. Authentication may be based on any desired criteria, which may or may not be related to any particular network service provider.

### Authentication Techniques

The authentication process basically requires that the repeater recognizes an approved mobile device from one which has not been approved for use with the repeater. This can be done by transmitting a unique code, such as a PIN number from the mobile to the repeater which is decoded and validated at the repeater. More secure forms of authentication may be used, for example by basing it on an exchange of coded information between the two devices, which is updated each time the devices are in proximity. Ideally the authentication process must be able to be used anywhere in the coverage area of the repeater. This includes the authentication process being performed using a wireless protocol with at least the same range as the repeater coverage range. A number of existing low cost technologies are suitable for this purpose including, active or passive RPID, Short Range Wireless and RF (CAS) signatures.

Active RFID: a small active RFID device can be embedded in or permanently attached to the Wireless Service Providers approved phone(s) and an RFID reader located in the repeater. Authentication would be based on acquiring a valid code or serial number from the RFID tag. An active RF ID tag is preferred for this purpose to obtain an adequate range from the repeater. Alternatively one or more RFID readers may be located throughout the coverage area.

Short Range Wireless: A separate short range wireless system can be used to provide a communications link between the mobile device and the repeater. Many examples of this type of system operate in unlicensed bands and have ranges compatible with the coverage area of a low power repeater, include including Zigbee and Bluetooth. The receivers for these technologies may be co-located with the repeater electronics, for example in the coverage unit or antenna, or distributed through the coverage area.

The short range wireless systems described use power for the transceiver and communications processor, and can be connected to the wireless terminal battery. As an example, Bluetooth chip sets are already built into many phones and are widely used to provide hands-free operation of the phone with a variety of accessory devices, providing a built-in transceiver at the wireless terminal that can also be used by the RAFBR. The Bluetooth protocol includes an authentication process that pairs the phone with the accessory device, and this could also be used to pair the phone(s) with a repeater. Class I Bluetooth devices also provide sufficient range for the authentication to occur throughout the coverage area.

RF Signatures: The phone provides an RF signature on top of the normal modulation that is detected by the repeater. This type of signaling, referred to as a Coverage Area Signature (CAS) is described in detail in the applicant's U.S. patent application No. 60/820,517. Because it is superimposed on the UL signal from the mobile device it is detectable from anywhere in the coverage area. Note that the mobile device need not necessarily be modified to transmit the signature. In the case of networks using uplink power control, if the repeater modulates the UL signals at the output of the repeater, the network will compensate for the change in signal seen at the Base-Station by adjusting the output power of the phone, i.e. the phone will be forced to create the signature, which can then be detected at the UL input to the repeater.

Passive RFID: Passive RFID sensors or other short range wireless authentication tags may also be easily attached to a wireless terminal allowing the wireless terminal to be authenticated by an RFID reader. This type of device does not require power source and can be attached to any wireless terminal. Because of the short range of these passive tags, using this technology, the RFID readers may be most conveniently located at the entrances to the indoor coverage area, for example at doorways, where the user will pass close to the reader when entering the coverage area.

It is also possible to detect some types of phone by characteristic signatures that are based on the unique frame structure inherent to a particular network, for example iDEN, GSM, UMTS and EVDO have distinct frame periods that create amplitude signatures in the phone waveform that can be detected using a correlator or digital filter, as described in the applicant's patent Ser. No. 11/071,641. This type of signature detection can be used to determine if a phone is operating on the correct network, but cannot be used to authenticate a specific phone.

### Authentication Process

The purpose of the authentication process is to prevent un-authorized phones, i.e. from other WSP, accessing the repeater and transmitting back to the network through it. Unless the phone is authenticated the repeater uplink is muted. A number of alternative authentication processes are described below.

### Area Based Authentication

In area based authentication the repeater normal state is for the UL to be muted. The phone and repeater are provided with the necessary information to complete the authentication process through a short range wireless link, such as RFID or Short Range Wireless as described in the previous section. The transceiver for this link can be conveniently co-located with the coverage antenna of the repeater, so that the coverage area and authentication area overlap. When an authorized phone is within the coverage area, the authentication process can be initiated from the phone (by means of the keypad), or can be designed to occur automatically whenever the short range link is established. Once authentication is achieved the repeater UL is enabled, allowing the phone to access the network through the repeater. In this method, the authentication process can be repeated periodically, so that if the phone is removed from the coverage area, the repeater UL can be muted shortly afterwards, denying access to unauthorized phones.

### UL Power Based Authentication

In this method the repeater UL is normally on and is only muted if the output power is above a certain power threshold (the regulatory limit for unwanted in-band emissions, for example). The authentication process is only initiated if an UL transmission is detected that exceeds the power threshold for a minimum length of time. If the authentication fails, the UL is muted for a time period which is long enough to cause the phone to halt transmission. The UL can then be un-muted ready for a valid transmission. To deny service, the power detection and authentication process are fast enough to prevent a call from being set up by the unauthorized phone, i.e. <1 second. This method has the advantage that the uplink is only muted, and for a short period of time, if an unauthorized mobile attempts to use the repeater.

### Activity Based Authentication

In this method the repeater UL is normally muted, and the authentication is only initiated by the phone when it needs to transmit to the host network. This can be done by initiating a transmission over a separate short range wireless link to open the UL just before the phone transmits. Alternatively an RF signature can be added to the UL transmission itself to authenticate the phone. In either case the authentication must be completed rapidly to allow the phone to send control and other short messages to the network without loss of data, and there must be an interface between the phone MAC or PHY and the short range wireless link to initiate the process. This interface may be supported, for example, where a Bluetooth service is embedded in the phones. The advantage of this process is that the repeater UL is only accessible to un-authorized phones when an authorized phone is actually transmitting.

Each authentication process has different features and complexity but, unlike the use of sub-band filtering, none involve adding significant hardware cost to the repeater or phone. The hardware for a short range wireless link may already be present in the phone, for example Bluetooth. These methods may also be combined to further improve the security of the repeater and minimize the possibility of use by un-authorized devices.

### Uplink Noise

The RAFBR uses the downlink signal power to set the downlink gain and output power using an AGC feedback system. The uplink gain is also controlled by this mechanism so that there is always a constant gain difference between downlink and uplink. Thus, if the repeater is close enough to a base-station to reduce the downlink gain, the uplink gain will be reduced by the same amount. The uplink gain control is arranged so that the reduction in gain also reduces the output noise by the same amount (i.e. it is implemented in the latter gain stages of the uplink). This ensures that the noise power received at the closest base-station (which could be on a different network than the network used by the authenticated wireless terminals) does not increase if the repeater is located in close proximity, and hence has no impact on the capacity of that network.

### Downlink Operation

To ensure that the phone can connect to the external network, it must have continuous access to the control and timing signals transmitted by the base-station. It is therefore not desirable to mute the downlink in the same was as the uplink. However, whereas the UL transmitter must have enough power to communicate with a distant base-station, up to 20 miles away, the DL transmitter only needs to transmit a signal over around 5000 ft to provide coverage throughout a 5000 sq ft building, for example. In a small area repeater therefore, the DL transmitter can therefore be much lower power, and can be made to comply with regulations for spurious or unwanted in-band emissions. The RAFBR can be made compatible with this requirement in North America by limiting the maximum composite power level in the DL to −13 dBm at the antenna input, using an automatic gain control system in the DL signal path. This power limit will apply to transmission from the desired and any other Wireless Service Providers using the band.

### Repeater Monitoring and Control Features

If the wireless terminal is equipped with the ability to exchange data with the repeater, i.e. via a short range wireless link, it can also be used to provide monitoring and control of the repeater. For example a message could be sent to the phone from the host network that causes the repeater to report back its status to the network, or, as a second example, to change the authentication code required to enable the link to the repeater so that a different set of user(s) are provided with access to the network though the repeater. In either case the connectivity between the phone and Network Operations Center is provided over an existing communications service, such as a short messaging service, or phone maintenance service, and carried over the wireless link to the RAFER.

To monitor the repeater automatically, the user's wireless terminal can also be configured to forward a message from the repeater to the network each time a valid area based authentication occurs, thus providing the status of the repeater along with other information, such as its serial number and location.

These messages could also be transmitted between the phone and the repeater using the CAS based signaling described in ref [3].

In an alternative method, the repeater is monitored and controlled via an independent communications link which uses the internet to provide connectivity to a central Network Operations Center. In this case the repeater is equipped with a wired or wireless LAN port that can connect to local residential or SOHO network. In this configuration, the local router and modem must be able to support on-demand access to the Repeater from the Network Operations Center.

The embodiment(s) of the invention described above is(are) intended to be representative only. The scope of the invention is therefore intended to be limited solely by the scope of the appended claims.

We claim:

1. A method of restricting access to communications services of a network by wireless terminals within a coverage area of a repeater, the method comprising:
attempting to authenticate a wireless terminal within a coverage area of a repeater;
if the authentication attempt is successful, enabling an up-link path of the repeater to permit access to the communication services; and
if the authentication attempt is not successful, disabling the uplink path to deny access to the communication services.

2. A method as claimed in claim 1, wherein the step of enabling the up-link path comprises a step of increasing a gain of the uplink path.

3. A method as claimed in claim 1, wherein the authentication is repeated continuously to determine whether the wireless terminal is still present.

4. A method as claimed in claim 3, wherein the uplink is disabled only after a predetermined period following a failed authentication attempt, such that the wireless terminal will not be disconnected from the network due to a single failed authentication.

5. A method as claimed in claim 1, wherein the enabling of the up-link path comprises controlling the uplink path gain based on a gain of a downlink path of the repeater, such that the wireless terminal can communicate with a base station of the network, and noise transmitted to the base station by the repeater is minimized.

6. A method as claimed in claim 1, wherein attempting to authenticate the wireless terminal comprises at least one of:
detecting a predetermined transmitted by the wireless terminal;
exchanging coded information between the repeater and the wireless terminal;
detecting a unique code from a passive tag attached to the wireless terminal;
detecting a frame structure of a signal transmitted by the wireless terminal; and
for wireless terminals with uplink power control, detecting a characteristic signature waveform created by modulating the repeater uplink output signals.

7. A method as claimed in claim 1, wherein the transceiver used to authenticate the wireless terminal comprises at least one of:
A transceiver or detector integrated into the repeater coverage unit or antenna;
One or more transceivers or detectors located within the coverage area of the repeater and connected to the repeater by a cable or other means; and
One or more transceivers or detectors located at the entrances to the coverage area of the repeater and connected to the repeater by a cable or other means.

8. A method as claimed in claim 1, wherein the downlink path of the repeater comprises one of:
A full band signal path with an output power limited through an automatic gain control sub-system to be less than the regulatory limit for out of band emissions; and
A signal path with sub-band filters that limit the downlink output power outside a desired sub-ban of operation.

9. A repeater for providing restricted access to communications services of a network by wireless terminals within a coverage area of the repeater, comprising:
a controller for attempting to authenticate a wireless terminal within the coverage area of the repeater; and
a mute control for selectively enabling or disabling an up-link path of the repeater, based on the result of the authentication attempt.

10. A repeater as claimed in claim 9; wherein the mute control comprises one of a variable gain amplifier and attenuator of the up-link path, the variable gain amplifier being controlled by a gain set signal from the controller in accordance with the authentication attempt result.

11. A method of restricting access to communications services of a network by wireless terminals within a coverage area of a repeater, the method comprising:
monitoring uplink power of the repeater with the uplink being enabled for transmissions above a pre-determined threshold;
if a signal is detected above the threshold, attempting to authenticate a respective wireless terminal within a coverage area of the repeater;
if the authentication attempt is successful, leaving an up-link path of the repeater enabled to permit access to the communication services; and
if the authentication attempt is not successful, disabling the uplink path momentarily to deny access to the communication services.

12. A method as claimed in claim 11, wherein the disabling of the up-link path comprises reducing a gain of the uplink path.

13. A method as claimed in claim 12, further comprising increasing the gain of the up-link path after a predetermined period of time.

14. A method as claimed in claim 13, wherein the predetermined period of time is selected to exceed a timeout condition of the wireless terminal, such that an unauthorized wireless terminal will stop transmitting before the up-link path is re-enabled.

15. A method as claimed in claim 11, wherein the enabling of the up-link path comprises controlling the uplink path gain based on a gain of a downlink path of the repeater, such that the wireless terminal communicates with a base station of the network, and noise transmitted to the base station by the repeater is minimized.

16. A method as claimed in claim 11, wherein attempting to authenticate the wireless terminal comprises at least one of:
detecting a predetermined PIN transmitted by the wireless terminal;
exchanging coded information between the repeater and the wireless terminal;
detecting a unique code from a passive tag attached to the wireless terminal;
detecting a frame structure of a signal transmitted by the wireless terminal; and
for wireless terminals with uplink power control, detecting a characteristic signature waveform created by modulating the repeater uplink output signals.

17. A method as claimed in claim 11, wherein the repeater used to authenticate the wireless terminal comprises at least one of:
a transceiver or detector integrated into a coverage unit of the repeater or antenna;
one or more transceivers or detectors located within the coverage area of the repeater and connected to the repeater by a cable or other means; and
one or more transceivers or detectors located at entrances to he coverage area of the repeater and connected to the repeater by a cable or other means.

18. A method as claimed in claim 11, wherein a downlink path of the repeater comprises one of:
A full band signal path with an output power limited through an automatic gain control sub-system to be less than the regulatory limit for out of band emissions; and
A signal path with sub-band filters that limit downlink output power outside a desired sub-ban of operation.

19. A method of restricting access to communications services of a network by wireless terminals within a coverage area of a repeater, the method comprising:
sending a message from the wireless terminal to the repeater over a wireless link whenever the wireless terminal needs to transmit to a macro network;
decoding and authenticating the message at the repeater to determine whether the originating wireless terminal is authorized to use the repeater;
if the authentication attempt is successful, leaving an up-link path of the repeater enabled to permit access to the communication services by the wireless terminal; and
if the authentication attempt is not successful, disabling the up-link path to deny access to the communication services by the wireless terminal.

20. A method as claimed in claim 19, wherein the disabling the up-link path comprises reducing a gain of the uplink path.

21. A method as claimed in claim 20, further comprising a increasing the gain of the up-link path after a predetermined period of time.

22. A method as claimed in claim 21, wherein the predetermined period is selected to exceed a timeout condition of the wireless terminal, such that an unauthorized wireless terminal will stop transmitting before the up-link path is re-enabled.

23. A method as claimed in claim 19, wherein the enabling the up-link path comprises controlling the up-link path gain based on a gain of a downlink path of the repeater, such that the wireless terminal communicates with a base station of the network, and noise transmitted to the base station by the repeater is minimized.

24. A method as claimed in claim 19 wherein authenticating the wireless terminal comprises at least one of:
detecting a predetermined PIN transmitted by the wireless terminal;
exchanging coded information between the repeater and the wireless terminal;
detecting a unique code from a passive tag attached to the wireless terminal;
detecting a frame structure of a signal transmitted by the wireless terminal; and
for wireless terminals with uplink power control, detecting a characteristic signature waveform created by modulating the repeater uplink output signals.

25. A method as claimed in claim 19, wherein the repeater used to authenticate the wireless terminal comprises at least one of:
one of a transceiver or detector integrated into the repeater coverage unit or antenna;
one or more transceivers or detectors located within a coverage area of the repeater and connected to the repeater by a cable or other means; and
one or more transceivers or detectors located at entrances to the coverage area of the repeater and connected to the repeater by a cable or other means.

26. A method as claimed in claim 19, wherein a downlink path of the repeater comprises one of:
a full band signal path with an output power limited through an automatic gain control sub-system to be less than a regulatory limit for out of band emissions; and
a signal path with sub-band filters that limit downlink output power outside a desired sub-ban of operation.
